(19) United States
(12) Patent Application Publication
(10) Pub. No.: US 2010/0155514 A1
(43) Pub. Date: Jun. 24, 2010

(54) DEVICE FOR REDUCING FIBROUS PRODUCTS

(75) Inventors: Garry Partington, Lancashire (GB); Wayne Nelson, Greater Manchester (GB)

Correspondence Address: BROOKS KUSHMAN P.C., 1000 TOWN CENTER, TWENTY-SECOND FLOOR, SOUTHFIELD, MI, 48075, US

(73) Assignee: VERNACARE LIMITED, Lancashire (GB)

(21) Appl. No.: 12/599,918

(22) PCT Filed: May 13, 2008
(86) PCT No.: PCT/GB08/50346

§ 371 Date: Mar. 1, 2010

(30) Foreign Application Priority Data
May 18, 2007 (GB) 0709555.7

(51) Int. Cl. B02C 23/00

(52) U.S. Cl. 241/33; 241/39

(57) ABSTRACT

A macerator has a housing (10) having an opening which provides access to its interior and a releasably securable lid (18) for releasably closing the opening in the housing. A foot-operated contactless infra red switch (64) is provided at the base of the macerator which is adapted to release a solenoid-operated latch (50) upon completion of the maceration cycle. The macerator also has a rotatable blade mounted within the housing (10). The blade is rotated by means of a three-phase motor. The macerator also has means (52) for converting a single-phase electrical power supply to a three-phase power supply for the motor.

The present invention relates to devices for reducing fibrous products. In particular, but not exclusively, the invention relates to macerators for reducing soiled paper pulp bed pans, urine bottles and the like to small particles, to enable them to be discharged into a sewer.

A typical macerator takes the form of a generally cylindrical, upright drum having a rotatable cutting blade disposed at its base and rotatable by means of an electric motor. In use, an article to be macerated is placed in the drum and a lid closes off the aperture. During the operating cycle, water is fed into the container and the motor is operated, causing the blade to rotate. The articles within the macerator are reduced to small particles, at a size which allows them to be discharged into a sewer.

Subsequent to discharging of the reduced products, the lid of the macerator can then be opened to allow the next soiled product to be introduced. Typically this is achieved either manually or by means of a mechanical foot pedal whose depression unlocks a latch and allows the lid to open by means of a spring.

The foot pedal region and the foot pedal mechanism itself is difficult to clean thoroughly and it has been found that this can form a site for the build-up of bacteria and viruses, particular when it is borne in mind the type of products which are commonly disposed of in a macerator. If unwanted bacteria and/or viruses build up on the foot pedal, they are transferred to the shoe of the operator. Since the operator is commonly a nurse or other assistant, such unwanted bacteria and/or viruses can then be spread over a wide area throughout the building in which the macerator is situated.

It is therefore a first object of the present invention to provide a macerator which reduces the likelihood of contamination with bacteria and/or viruses.

In another aspect, the very nature of the task which macerators perform means that they are repeatedly in use at all times of the day and night it is essential for macerators to be reliable since in the event of a malfunction it will be necessary to transport soiled articles to be macerated to an operative macerator, thereby increasing the risk of cross-contamination and infection during such transport, or for soiled articles to build up in a sluice room until the macerator is repaired.

In order to maximise the reliability of macerators, the electric motor within the macerator is normally a three-phase motor. This is considerably more reliable than a single-phase motor and has the additional advantages of being quieter and having a higher start-up torque than single-phase motors.

The disadvantage of using a macerator with a three-phase motor, however, is that a dedicated three-phase supply is required and installation must be performed by a qualified electrician. It is not always feasible for a three-phase electric supply to be provided. In such cases, it is then necessary to install a macerator with a single-phase electric motor, thereby introducing the disadvantages of poorer reliability, increased noise and lower start-up torque.

In accordance with a first aspect of the present invention, a macerator comprises a housing, an opening in the housing providing access to its interior, a releasably securable closure for releasably closing the opening in the housing and a contactless switch for controlling a function of the macerator.

The provision of a contactless switch reduces the likelihood of transfer of bacteria and viruses to the macerator and onward transfer to other sites. It also reduces the physical burden on a user of the macerator as compared with prior art macerators, which require physical manipulation or displacement of controls, e.g. depression of a foot pedal.

In addition, a contactless switch has no moving parts and therefore can be designed to be much easier to clean than, for example, the pedal arrangements of the prior art.

Preferably, the macerator is adapted to rest on a base portion and the contactless switch is located at or adjacent to the base portion, preferably at or adjacent to ground level.

Most preferably, the contactless switch means comprises a recess for receipt of part of a user's foot. This allows a user to operate the contactless switch without the use of hands, which may be useful if the user is carrying other articles. The facility to use ones foot also reduces the risk of cross-contamination via the hands.

The contactless switch means may conveniently comprise a housing, which is preferably integrally formed, e.g. as a one-piece moulding.

In one embodiment, the contactless switch means comprises an emitter and a receiver and the switch is operated by interruption of communication between the emitter and the receiver. For example, the contactless switch means may comprises means for emitting electromagnetic radiation (e.g. infra-red radiation) and means for detecting the electromagnetic radiation.

Preferably, the contactless switch is located externally of the housing.

The macerator preferably further comprises a lock for releasably securing the opening in the closed position and preferably the actuation of the switch is adapted to control the operation of the lock means, e.g. to release the lock means.

The macerator preferably further comprises control means to which the contactless switch means is connected.

Preferably the control means is programmable and preferably comprises a microprocessor.

In accordance with a second aspect of the present invention, a macerator comprises a housing, an opening in the housing providing access to its interior, a releasably securable closure for releasably closing the opening in the housing, movable blade means within the housing, a multi-phase electric motor adapted to move the blade means and means for converting an electrical power supply of a different number of phases from that of the electric motor to the same number of phases as that of the electric motor.

This allows a multi-phase motor (e.g. a three-phase motor) to be operated from a single-phase power supply. As a result, the macerator can be installed without the need for a three-phase supply and in particular can be used with a single-phase power supply. As mentioned previously, three-phase motors are more reliable and quieter than single-phase motors and produce a higher start-up torque. In addition, a three-phase motor con be configured to reverse when the blade means is jammed, allowing the blade means the opportunity to free itself a predetermined number of times (e.g. three times) before a fault is recognised.

Preferably, the multi-phase electric motor comprises a three-phase motor and preferably the macerator comprises means for converting a single-phase power supply to a three-phase power supply.

The means for converting the electrical power supply preferably comprises an inverter.

The macerator preferably further comprises a plurality of rails upon which the means for converting the electric power supply is mounted, to facilitate installation, removal and servicing.

Preferably, the blade means are rotatable and the multi-phase electric motor is adapted to rotate the blade means.

In one embodiment, the macerator comprises a support frame formed from a plurality of support frame sections adapted to be secured together. This facilitates transport of the frame components.

By way of example only, a specific embodiment of the present invention will now be described with reference to the accompanying drawings, in which:

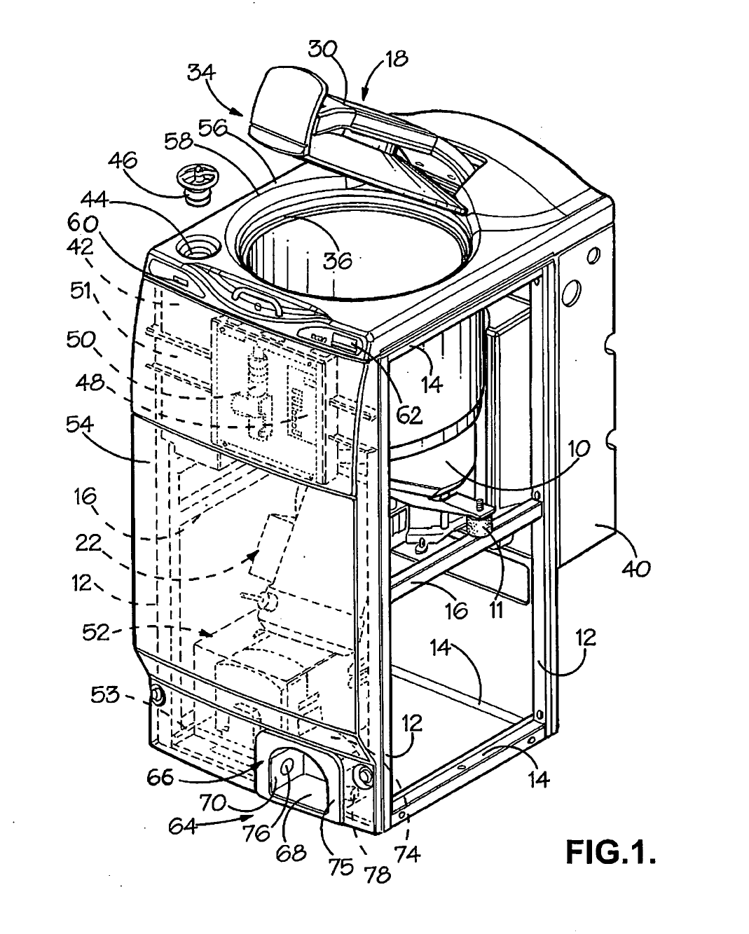

FIG. 1 is a perspective, part cut-away view of an embodiment of macerator in accordance with the present invention;

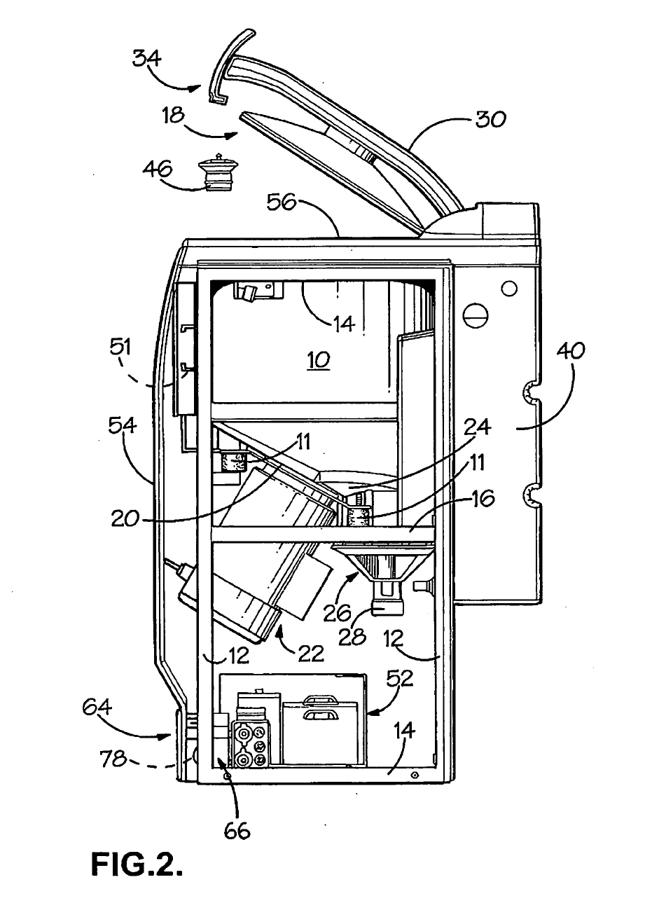

FIG. 2 is a cut-away side view of the macerator of FIG. 1; and

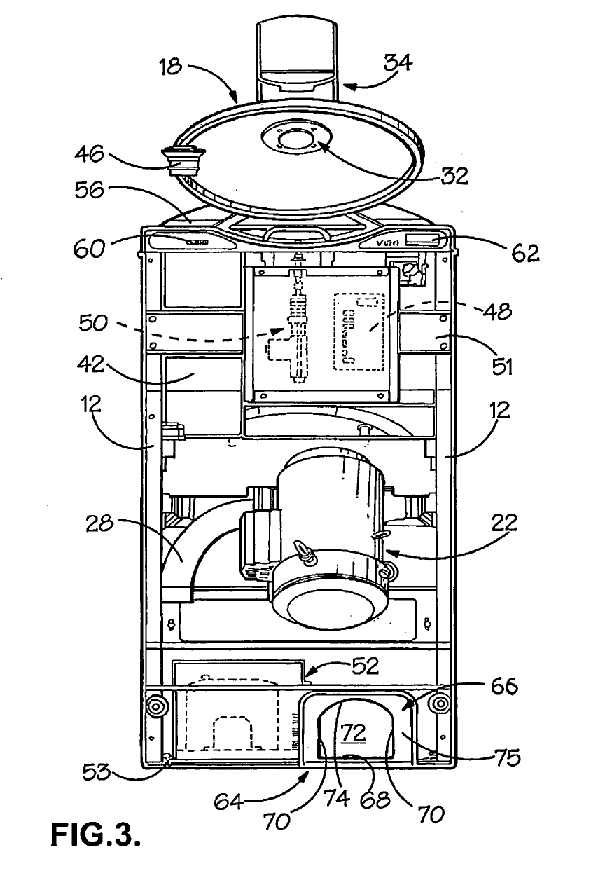

FIG. 3 is a cut-away front view of the macerator of FIG. 1.

FIGS. 1 and 2 illustrate a top-loading macerator which is intended for the disposal of soiled paper pulp bed pans, urine bottles and the like in a hospital, nursing home or similar environment. The macerator is very similar to that described in EP-A-0347205 and comprises a stainless steel drum 10 supported via rubber bushes 11 on a framework having four vertical legs 12 arranged in a square formation and eight cross-members 14 interconnecting the upper ends and the lower ends of the legs. Two further horizontal cross-members 16, upon which the lower rubber bushes 11 are mounted, extend between the mid-points of the front and rear vertical legs on each side of the framework. The frame is conveniently formed from four pre-constructed sections, for ease of transport, and is subsequently assembled and bolted together. The upper end of the drum is 10 open and is provided with a hinged closable lid 18.

The drum comprises a generally cylindrical stainless steel casing having a generally flat, inclined base wall portion 20. A plurality of macerator blades (not visible) lie immediately above the base wall portion within the drum 10. The macerator blades are mounted on a drive shaft that passes sealingly through an aperture in the inclined base wall. The drive shaft is connected to a three-phase electric motor 22 which is secured to the underside of the inclined base wall.

The lower end of the macerator drum 10 is closed off by a base with a gently downwardly sloping, generally frusto-conical portion 24 having a circular exit aperture at its base. The aperture may be selectively closed off by means of a diaphragm valve 26 secured to the undersurface of the frusto-conical portion 24. When the valve 26 is opened the aperture communicates with an outlet pipe 28 which leads to the normal domestic sewer system.

The hinged lid 18 by means of which the upper end of the drum is selectively closable is circular and generally frusto-conical in shape. The lid 18 is mounted on a support arm 30 which is pivotally mounted to the framework of the macerator. The lid is biased towards the open position as shown in the figures by means of a spring (not visible) located at the pivot of the support arm 30. The arm is hollow and receives a pipe which supplies water to a spray head 32 in the centre of the under surface of the lid. The distal end of the arm 30 is provided with a catch 34 for securing the lid in the closed position, as will be explained. A continuous, circular seal 36 is provided around the periphery of the open upper end of the drum 10 for sealing engagement with the lid 18.

A water cistern 40 is mounted on the frame at the rear of the device. A reservoir 42 for storing and dispensing deodorising liquid is also mounted on the frame, towards the front left-hand side (when viewed from the front). The deodoriser reservoir 42 can be refilled via an opening 44 in the upper face of the macerator, which can be closed off with a removable cap 46. A programmable, microprocessor-based circuit board 48 and solenoid-operated latch 50 are also mounted on an additional cross-member 51 extending between the two frontmost upright frame members 12.

It will also be observed that an inverter and power supply unit 52 is mounted on the base of the macerator, the unit being connectable to a standard single-phase mains power supply. The unit 52 is mounted on rails 53 secured to the frame of the macerator to facilitate its installation, removal and servicing. The inverter unit converts an incoming single-phase power supply to a three-phase power supply for supply to the three-phase motor 22. The inverter and power supply unit 52 also provides appropriate low-voltage DC outputs for controlling the other functions of the macerator.

In use the front, sides and top of the macerator are covered with a front panel 54, side panels (omitted from the drawings for clarity) and a top panel 56 respectively, which enclose the framework members 18, the macerator drum 10, the electric motor 22, the inverter unit 52, deodoriser reservoir 42, circuit board 48 and latch 50. It will also be noted that the top panel 56 includes a circular aperture 58 which corresponds to the aperture in the top of the macerator drum and to the hinged lid, and an aperture which corresponds to the opening 44 for refilling the deodoriser reservoir 42 as previously described.

A start button 60 and a liquid crystal display 62 for showing cycle stages and indicating faults are provided on the front edge of the top panel at the left and right-hand sides respectively.

At the base of the front panel, outside the drum at ground level, towards the right-hand side when viewed from the front, is provided a contactless foot-operated switching arrangement 64 for opening the lid. The switching arrangement comprises a moulded housing 66 set into a complementarily-shaped aperture in the front panel 54. The housing 66 is moulded from plastics and comprises a planar horizontal base wall 68, two parallel side walls 70 extending perpendicularly to the base, a rear wall 72 extending perpendicularly to the base wall 68 and side walls 70 and an arched top wall 74 extending between the side walls 70 and the rear wall 72. The front of the housing 66 is open and a peripheral planar flange 75, which abuts the adjacent portion of the front panel 54, is provided around the opening of the housing 66. The housing 66 is a one-piece moulding and therefore there are no joints through which liquid can permeate. The recess of the housing 66 is of a size and shape to accommodate the front part of a shoe and is used to unlock the latch 50 and open the lid, as will be explained.

On one of the side walls 70 an infra-red LED 76 is located and on the opposite side wall an infra-red detector 78 (e.g. an infra-red light dependent resistor or IR-LDR), is located.

The infra-red light source 76 and infra-red detector 78 are aligned, whereby the detector 78 normally detects infra-red pulses emitted from the infra-red LED 76. However, when a user's foot is located within the housing, communication between the infra-red LED 76 and the infra-red detector 78 is interrupted. The output of the infra-red detector 78 is connected to the circuit board 48 which, if the macerator has completed its cycle, will actuate the solenoid to withdraw the locking bolt 50 from the catch 34 on the lid 18, thereby allowing the lid 18 to hinge upwardly by virtue of the spring biasing force acting on the support arm 30.

In use, one or more articles to be disposed of are placed in the drum 10 and the lid 18 is hinged shut until the catch 34 on the lid engages with the solenoid-operated latch 50, thereby locking the lid shut. The start button 60 is then depressed, which commences the macerator cycle. The precise details of the macerator cycle depend on the functions programmed into the circuit board 48 but typically comprise the closing of the diaphragm valve 26, introduction of water into the closed drum 10 via the spray head 32, actuation of the motor 22 to reduce the products within the drum to small particles, opening of the diaphragm valve, stopping the motor 22 and spraying rinsing water via spray head 32, preferably containing liquid pumped from the deodorising fluid reservoir 42 by a pump (not shown).

When the cycle has finished and it is desired to open the lid 18 to introduce further articles to be disposed of, a user places his or her foot into the aperture defined by the housing 66 at the base of the front panel of the macerator. As explained previously, this breaks the communication between the infra-red LED 76 and the infra-red detector 78 and generates a signal indicative that the user wants to open the lid. The signal is sent to the control panel which, if the macerator cycle has finished, actuates the solenoid-operated latch 50 to free the catch 34 on the lid 18. The lid 18 then pivots open as a result of its spring-loaded mounting as described previously. The control panel 48 is set up to prevent unlatching of the lid unless the macerator cycle has been completed.

The invention is not restricted to the details of the foregoing embodiment. For example, the contactless foot switch may be arranged to control different, or additional, functions as compared with that described. For example, the switch may be arranged to provide a sequential signal to start the cycle and then to release the lid when the cycle has finished.

1. A macerator comprising a housing, an opening in the housing providing access to its interior, a releasably securable closure for releasably closing the opening in the housing and a contactless switch for controlling a function of the macerator.

2. A macerator as claimed in claim 1, wherein the macerator is adapted to rest on a base portion and wherein the contactless switch is located at or adjacent to the base portion.

3. A macerator as claimed in claim 2, wherein the contactless switch is located at or adjacent to ground level.

4. A macerator as claimed in claim 1, wherein the contactless switch means comprises a recess for receipt of part of a user's foot.

5. A macerator as claimed in claim 1, wherein the contactless switch means comprises a housing.

6. A macerator as claimed in claim 5, wherein the housing is integrally formed.

7. A macerator as claimed in claim 6, wherein the housing of the contactless switch comprises a one-piece moulding.

8. A macerator as claimed in claim 1, wherein the contactless switch comprises an emitter and a receiver and wherein the switch is operated by interruption of communication between the emitter and the receiver.

9. A macerator as claimed in claim 7, wherein the contactless switch comprises means for emitting electromagnetic radiation and means for detecting electromagnetic radiation.

10. A macerator as claimed in claim 8, wherein the contactless switch comprises means for generating infra red radiation and means for detecting infra red radiation.

11. A macerator as claimed in claim 1, wherein the contactless switch is located externally of the housing.

12. A macerator as claimed in claim 1, further comprising a lock for releasably securing the opening in a closed position and wherein actuation of the switch is adapted to control operation of a lock means.

13. A macerator as claimed in claim 12, wherein actuation of the switch is adapted to release the lock means.

14. A macerator as claimed in claim 1, further comprising control means to which the contactless switch means is connected.

15. A macerator as claimed in claim 14, wherein the control means is programmable.

16. A macerator as claimed in claim 14, wherein the control means comprises a microprocessor.

17. A macerator comprising a housing, an opening in the housing providing access to its interior, a releasably securable closure for releasably closing the opening in the housing, movable blade means within the housing, a multi-phase electric motor adapted to move the blade means and means for converting an electrical power supply of a different number of phases from that of the electric motor to the same number of phases as that of the electric motor.

18. A macerator as claimed in claim 17, wherein the multi-phase electric motor comprises a three-phase motor.

19. A macerator as claimed in claim 18, comprising means for converting a single-phase power supply to a three-phase power supply.

20. A macerator as claimed in claim 17, wherein the means for converting the electrical power supply comprises an inverter.

21. A macerator as claimed in claim 17, further comprising a plurality of rails upon which the means for converting the electric power supply is mounted.

22. A macerator as claimed in claim 17, wherein the blade means are rotatable and wherein the multi-phase electric motor is adapted to rotate the blade means.

23. A macerator as claimed in claim 1, comprising a support frame formed from a plurality of support frame sections adapted to be secured together.
